(19) United States
(12) Patent Application Publication
(10) Pub. No.: US 2017/0022800 A1
(43) Pub. Date: Jan. 26, 2017

(54) Tracker With Electronic Compass And Method Of Use

(71) Applicant: The Charles Machine Works, Inc., Perry, OK (US)

(72) Inventors: Brent W. Perteet, Stillwater, OK (US); Scott B. Cole, Edmond, OK (US); Bradley S. Marshall, Perry, OK (US)

(21) Appl. No.: 15/216,247

(22) Filed: Jul. 21, 2016

Related U.S. Application Data
(60) Provisional application No. 62/195,010, filed on Jul. 21, 2015.

(51) Int. Cl. E21B 47/024; G01V 3/28; E21B 7/04; G01V 3/34

(52) U.S. Cl. CPC E21B 47/024; G01V 3/34; G01V 3/28; E21B 7/046

(57) ABSTRACT

An underground signal transmitter is located near a drill bit on a downhole tool. An above-ground tracker determines the relative orientations of the transmitter and tracker. The tracker also has a compass for determining the tracker's orientation relative to magnetic north. A central processing unit within the tracker uses compass and relative orientation data to calculate the orientation of the transmitter relative to magnetic north. This information can be used to map the bore path and make course corrections.

### CROSS REFERENCE TO RELATED APPLICATION

This application claims the benefit of U.S. Provisional Patent Application Ser. No. 62/195,010 filed on Jul. 21, 2015, the entire contents of which are incorporated herein by reference.

### FIELD

This invention relates generally to a method and apparatus for tracking an underground transmitter and determining the transmitter's orientation relative to magnetic north.

### SUMMARY

The invention is directed to a tracker. The tracker comprises a tri-axial antenna, a compass, and a processor. The tri-axial antenna detects a depth and an orientation of an underground transmitter. The compass detects the orientation of the tracker relative to magnetic north and the processor determines the orientation of the underground transmitter relative to magnetic north.

### BRIEF DESCRIPTION OF THE DRAWINGS

FIG. 1 is an illustration of a horizontal directional drilling system for drilling a horizontal borehole and a tracking system built in accordance with the present invention.

FIG. 2 is a perspective view of a field tracker constructed in accordance with the present invention.

FIG. 3 is a perspective, partially cutaway view of a support structure for an antenna assembly for use with the present invention.

FIG. 4 is a perspective, partially cut-away view of the antenna assembly from FIG. 3.

FIG. 5 shows an alternative embodiment for an antenna assembly for use with the present invention.

FIG. 6 is a block diagram of a portable area monitoring system constructed to detect and process signals emanating from a boring tool.

FIG. 7 is a geometric representation of the relationship between the receiver and transmitter orientations and cardinal directions.

FIG. 8 is a screenshot of the visual display of the present invention.

FIG. 9 is an alternative screenshot of the visual display of the present invention.

### DETAILED DESCRIPTION

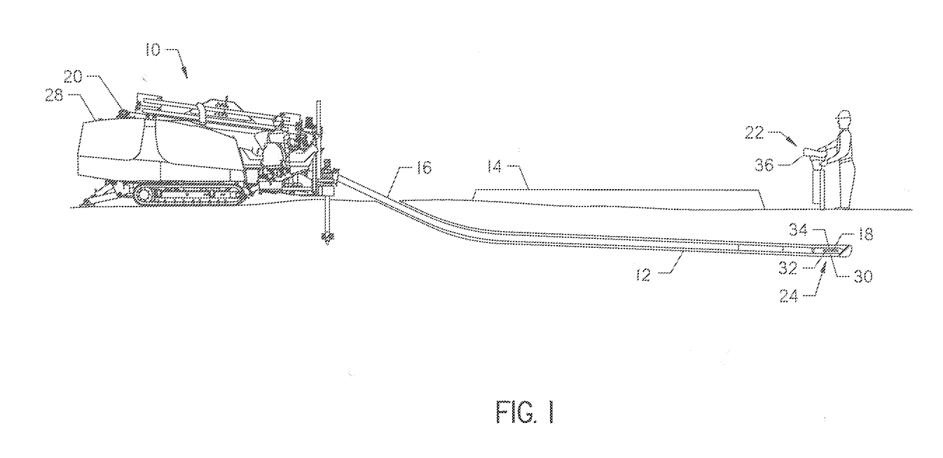

With reference now to the drawings in general, and FIG. 1 in particular, there is shown therein a horizontal directional drilling system (“HDD”) system 10 for use with the present invention. FIG. 1 illustrates the usefulness of horizontal directional drilling by demonstrating that a borehole 12 can be made without disturbing an above-ground structure, namely a roadway or walkway as denoted by reference numeral 14. To cut or drill the borehole 12, a drill string 16 carrying a drill bit 18 is rotationally driven by a rotary drive system 20.

When the HDD system 10 is used for drilling a borehole 12, monitoring the position of the drill bit 18 is critical to accurate placement of the borehole and subsequently installed utilities. The present invention is directed to a system 22 and method for tracking and monitoring the absolute orientation of a downhole tool assembly 24 during a horizontal directional drilling operation.

The HDD system 10 of the present invention is suitable for near-horizontal subsurface placement of utility services, for example under the roadway 14, building, river, or other obstacle. The tracking system 22 for use with the HDD system 10 is particularly suited for providing an accurate three-dimensional locate of the downhole tool assembly 24 from a position above ground. The locating and monitoring operation with the present tracking system 22 is advantageous in that it may be accomplished in a single operation. The present invention also permits the position of the downhole tool assembly 24 to be monitored without requiring the tracking system 22 be placed directly over a transmitter in the downhole tool assembly.

With continued reference to FIG. 1, the HDD system 10 comprises a drilling machine 28 operatively connected by the drill string 16 to the downhole tool assembly 24. The downhole tool assembly 24 preferably comprises the drill bit 18 or other directional boring tool, and an electronics package 30. The electronics package 30 comprises a transmitter 32 for emitting a signal through the ground. Preferably the transmitter 32 comprises a dipole antenna that emits a magnetic dipole field. The electronics package 30 may also comprise a plurality of sensors 34 for detecting operational characteristics of the downhole tool assembly 24 and the drill bit 18.

The plurality of sensors 34 may generally comprise sensors such as a roll sensor to sense the roll position of the drill bit 18, a pitch sensor to sense the pitch of the drill bit, a temperature sensor to sense the temperature in the electronics package 30, and a voltage sensor to indicate battery status. The information detected by the plurality of sensors 34 is preferably communicated from the downhole tool assembly 24 on the signal transmitted by the transmitter 32 using modulation or other known techniques.

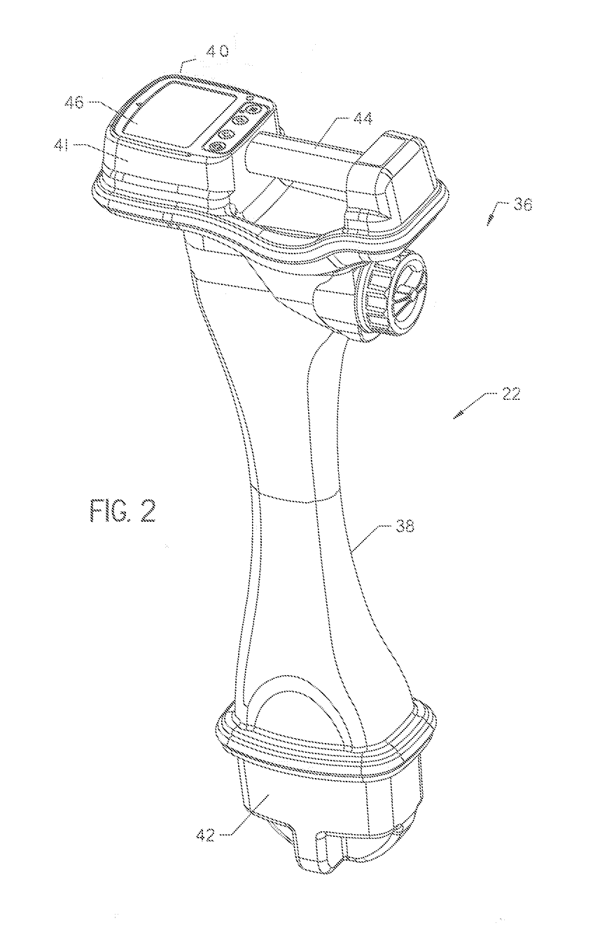

With reference now to FIG. 2, shown therein is a preferred embodiment of the tracking system 22 of the present invention. The tracking system 22 comprises a field tracker 36. The field tracker 36 comprises a frame 38, a computer processor 40, a compass 41 and the antenna arrangement 42 supported by the frame. The processor 40 is supported on the frame 38 and operatively connected to a compass 41 and an antenna arrangement 42. The frame 38 is preferably of lightweight construction and capable of being carried by an operator using a handle 44.

The field tracker 36 also comprises a visual display 46 and a battery (not shown) for providing power to the various parts of the field tracker. The visual display 46 may provide a visual representation of the tracking system 22 relative to the drill bit 18 and magnetic north, and other information useful to the operator. The field tracker 36 may also comprise a transmitting antenna (not shown) for transmitting information from the field tracker to the drilling machine 28 or other remote system (not shown).

The antenna arrangement 42 is supported on the frame 38. In the embodiment of FIG. 2, the antenna arrangement 42 is located at a bottom end of the frame 38 and the display 46 at a top end of the frame.

The antenna arrangement 42 preferably utilizes a tri-axial antenna. Such an antenna arrangement 42 is adapted to measure the total magnetic field generated by the transmitter 32 at its position on the frame 38. Preferably, the antenna arrangement 42 comprises three electromagnetically independent antennas, aligned on each of three orthogonal axes that share a common origin. Each antenna measures the magnetic field along the axis with which it is aligned. Each of the three orthogonal antenna signals is sent to the processor 40 and squared, summed, and then the square root is taken to obtain the total field.

The antenna arrangement 42 may utilize one or more individual antennas separated from each other by a known distance and in known relative positions. The separation and relative position of the antenna arrangements 42 may be selected based on the number of antenna arrangements and antenna design, size, and power.

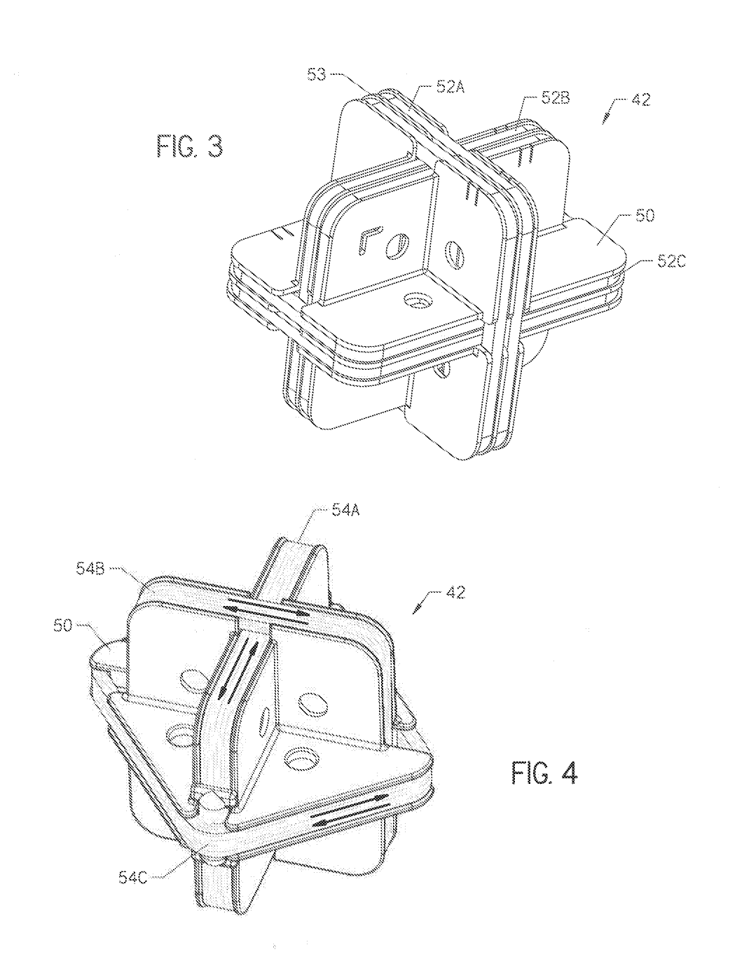

Referring now to FIGS. 3 and 4, there is shown therein an antenna arrangement 42 for use with the present invention. The antenna arrangement 42 comprises a support structure 50 defining three channels 52a, 52b, 52c. The support structure 50 is preferably formed of lightweight plastic. For ease of construction, the structure 50 may be manufactured in at least two parts that are secured together. The structure 50 may be manufactured in such a way that three channels 52 are each dimensionally similar. More preferably, the support structure 50 has a substantially cubical shape and each of the three channels 52a-c defines a rectangular aperture area having a center point. Most preferably, the channels 52a-c are mutually orthogonal and oriented so that the center points are coincident. A partition 53 is provided in the center of each channel 52a-c.

The channels 52 are orthogonally oriented such that a first channel 52a is circumvented by a second channel 52b, and a third channel 52c circumvents the first channel 52a and the second channel 52b. A preferred embodiment for such an arrangement comprises an orientation where a long side of the rectangular second channel 52b is adjacent to and perpendicular to a short side of the rectangular first channel 52a, and a diagonal of the rectangular third channel 52c is substantially coincident with a plane formed by the rectangular second channel. The size of the antenna arrangement 42 can be optimized by designing the channels 52 such that the diagonal of the third channel 52c intersects the plane of the second channel 52b at an angle of between 0-10 degrees. Most preferably, the diagonal of the third channel 52c will intersect the plane of the second channel 52b at an angle of approximately 4 degrees.

Shown in FIG. 4, the antenna arrangement 42 further comprises three antenna coils 54. The coils 54 are preferably windings of magnet wire. The three coils 54 are separately wound around the structure 50, one in each of the three channels 52a, 52b, and 52c, to form three coil loops 54a, 54b, and 54c. Because of the orientation of the channels 52a, 52b, and 52c, as previously described, the coils 54a, 54b, and 54c do not contact each other when positioned in the channels.

The coils 54 may comprise approximately 100 turns of magnet wire, though other numbers of turns may be used depending on wire size and antenna sensitivity or other design considerations. Due to the channel configuration, the coil loops 54a-c all have coincident center points, and their sensitivities are substantially identical. The coil loops 54a-c also define substantially identical aperture areas and have rounded corners. Since the coils 54 are wound with magnet wire, their resistances are relatively low.

The antenna arrangement 42 can be tuned to increase its sensitivity, thus allowing the field tracker 36 to detect the magnetic field from greater depths. Each channel 52a-c may be subdivided by the partition 53 and the coil loops 54a-c wound in opposite directions on each side of the partition to eliminate field interference associated with the direction of the coil loop.

Applicants' invention also contemplates other embodiments for the antenna arrangement 42, including use of traditional ferrite rod antennas. For example, the antenna arrangement 42 could comprise three ferrite rod antennas in orthogonal relationship.

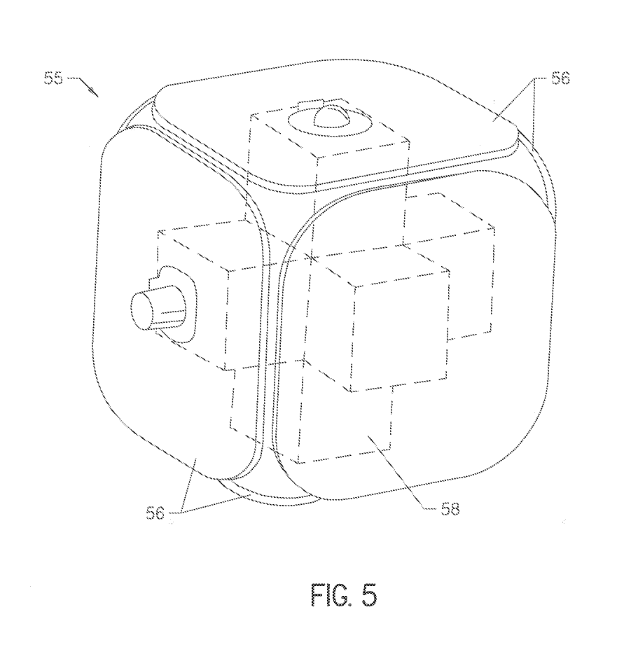

Referring now to FIG. 5, there is shown therein an alternative embodiment replacing the antenna arrangement 42 of the previous figures with an alternative antenna arrangement 55 for use with the present invention. As shown in FIG. 5, the antenna arrangement 55 comprises three tri-axial antennas made of printed circuit boards 56 (PCBs). Preferably, the PCBs 56 are supported on a mount 58 and configured as a prism. When configured, the PCBs 56 antennas can be mounted such that their respective axes are perpendicular and a geometric center of the antenna arrangement 55 will not change as the antenna arrangement is maneuvered. Using PCBs 56 for the antenna arrangement 55 allows the observation point for calculation of the total field sensed by the antenna arrangement 55 to remain at the geometric center of the antenna. Additionally, because PCBs may be manufactured by precision machines, dimensional tolerances can be lower than in an antenna arrangement that uses windings that are coiled by hand.

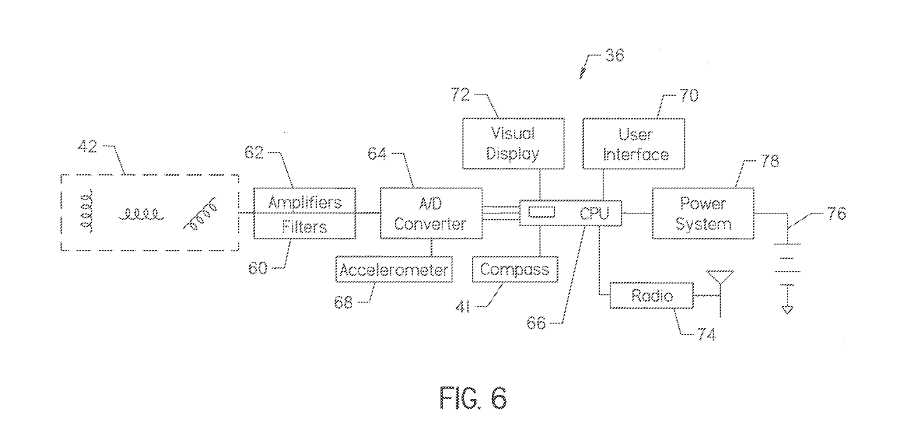

With reference now to FIG. 6, shown therein is a block diagram of the field tracker 36 of the present invention. The antenna arrangement 42, as described earlier, detects a change in the magnetic field induced by the transmitter 32 (FIG. 1). A change in the magnetic field sensed will result in a voltage being induced in response to the transmitter's magnetic field. A signal indicative of the measured voltage is sent from the antenna arrangement 42 to filters 60 and amplifiers 62. Filters 60 attenuate or eliminate portions of the antenna output signal attributable to local noise sources. Amplifiers 62 increase the output signal sent by the antenna arrangement 42. An A/D converter 64 may be used to convert analog waveform information into digital data.

The digital data from the A/D converter 64 is then sent to a central processor 66. The CPU 66 may comprise a digital signal processor (DSP) and a microcontroller. The CPU 66 decodes the information from the A/D converter 64 and performs calculations and use that information to determine the location and orientation of the transmitter relative to the antenna arrangement 42. The CPU 66 may also discern information transmitted on the magnetic field, to determine the battery status, pitch, roll, and other information about the downhole tool assembly 24.

The field tracker 36 may also comprise one or more additional sensors 68 used to sense operational information about the field tracker 36. For example, one or more accelerometers, or inclination and orientation sensors or magnetic compasses, may provide information concerning the roll or tilt of the field tracker 36. Further, the sensors 68 may include a global positioning system (GPS) location sensor. Information from the sensors 68 is provided to the A/D converter 64 and to the CPU 66 where the digital signal processor may make calculations to compensate for the field tracker 36 not being level.

The field tracker 36 further comprises a user interface 70 having plurality of buttons, joysticks, and other input devices. The operator can input information for use by the CPU 66 through the user interface 70. Information entered through the user interface 70 or determined or used by the CPU 66 may be displayed to the operator on the visual display 46 screen. The field tracker 36 also comprises a radio antenna 74 for transmitting information from the CPU 66 to a remote unit, such as at the drilling machine 10.

The field tracker 36 is preferably powered by a battery assembly 76 and power regulation system 78. The battery assembly 76 may comprise multiple D-cell sized batteries, though other sources are contemplated, such as rechargeable batteries. The power regulation system 78 may comprise a linear regulator or switch mode regulator to provide power to the various components of the field tracker 36.

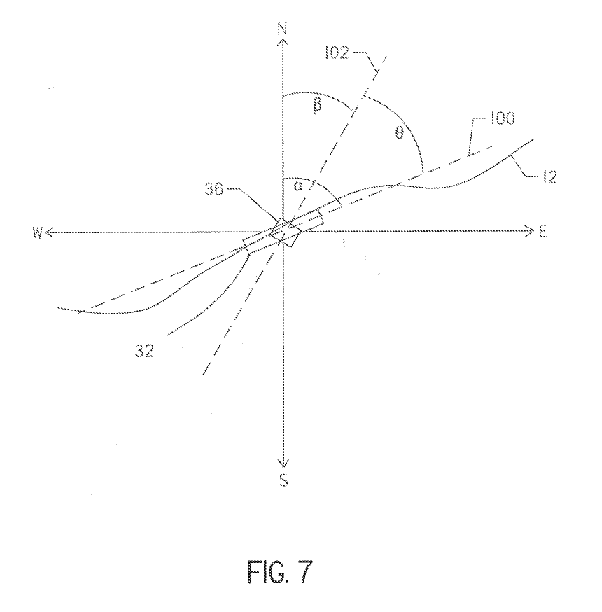

With reference now to FIG. 7, the field tracker 36 can be set directly on the desired path for the borehole 12. The display 46 can then be used to provide the operator with immediate feedback of the location and heading of the drill bit 18 relative to the desired path. Likewise, if the field tracker 36 is placed directly above the transmitter 32, the “z-axis” value will be zero. The field components from the x-axis and y-axis form the detected horizontal plane, and can be used to determine the angle of the transmitter 32 relative to the receiver. The angle θ is the relative angle between the orientation 100 of the transmitter 32 and the orientation 102 of the field tracker 36. Where the measured field components at the receiver are “b”,

$$tan θ = \frac{{b}_{y}}{{b}_{x}} .$$

While the angle θ is useful, it is not instructive in determining the absolute heading of lines 100 and 102 relative to magnetic north. The compass 41 must be utilized to determine such absolute headings.

The compass 41 may comprise a tri-axial microelectromechanical (MEMS) magnetometer. The compass 41 measures the Earth's magnetic field to determine the orientation of the field tracker 36 with respect to magnetic north. The calculated orientation of the field tracker 36 relative to magnetic north is the angle β.

Tilt may cause the calculation of both angle θ and β to be inaccurate due to changes in the component magnetic field across the antenna arrangement 42. Sensors 68 such as a MEMS accelerometer may be utilized to compensate for tilt of the field tracker 36.

The compass 41 sends signals to the CPU 66 to calculate the orientation 100 of the transmitter 32 relative to magnetic north. The relative heading θ is combined with the absolute heading 102 of the tracker β to generate the absolute heading of the transmitter 32 relative to magnetic north. To determine the absolute heading of the transmitter 32, angle α:

α=β+θ

The measured relative heading α may be used during HDD drilling operations to communicate steering correction information to the drill 10 operator, to log orientation information, plot GPS coordinates in conjunction with the orientation, provide course corrections, and generate maps. The CPU 66 may perform one or more of the above functions.

A method for creating a horizontal directional borehole 12 in the earth is also accomplished with the following steps. First, the drill bit 18 is advanced into a bore hole 12 by the horizontal directional drilling system 10. The field tracker 36 is placed on the ground in the proximity of the drill bit 18 with the field tracker aligned with the desired bore path 12. As the drill bit 18 is advanced forward with or without rotation, an image of the orientation of the drill bit relative to the field tracker 36 and magnetic north due to the readings from compass 41 can be transmitted from the receiver to the HDD system 10 and its operator. The calculated absolute heading may determine that the drill bit 18 is properly oriented and that the downhole tool assembly 24 only needs to be steered to maintain the proper bore path. Alternatively, a steering correction may be provided such that the drill bit 18 can be steered to correct the deviations from the planned bore path.

Additionally, the distance of forward advance of the drill bit 18 can be determined at the field tracker 36 and that information also transmitted from the receiver to the HDD system 10. Such techniques are useful when boring on-grade boreholes or when desiring to bore to a point where the field tracker 36 is positioned. The field tracker 36 may be moved to a second above-ground location to further detect the orientation and progress of the transmitter 32.

The absolute orientation data provided by the CPU facilitates the use of existing maps to plot a bore path. Absolute orientation data, provided by the CPU, may be combined with absolute location data, provided by GPS, to map a planned bore path. Thus mapped, the planned path can avoid previously-mapped obstructions, such as underground utility lines. Additionally, GPS coordinates of a planned bore path 12 may be plotted and the system 10 of the present invention used to provide course correction to maintain the transmitter 32 along the planned bore path 12.

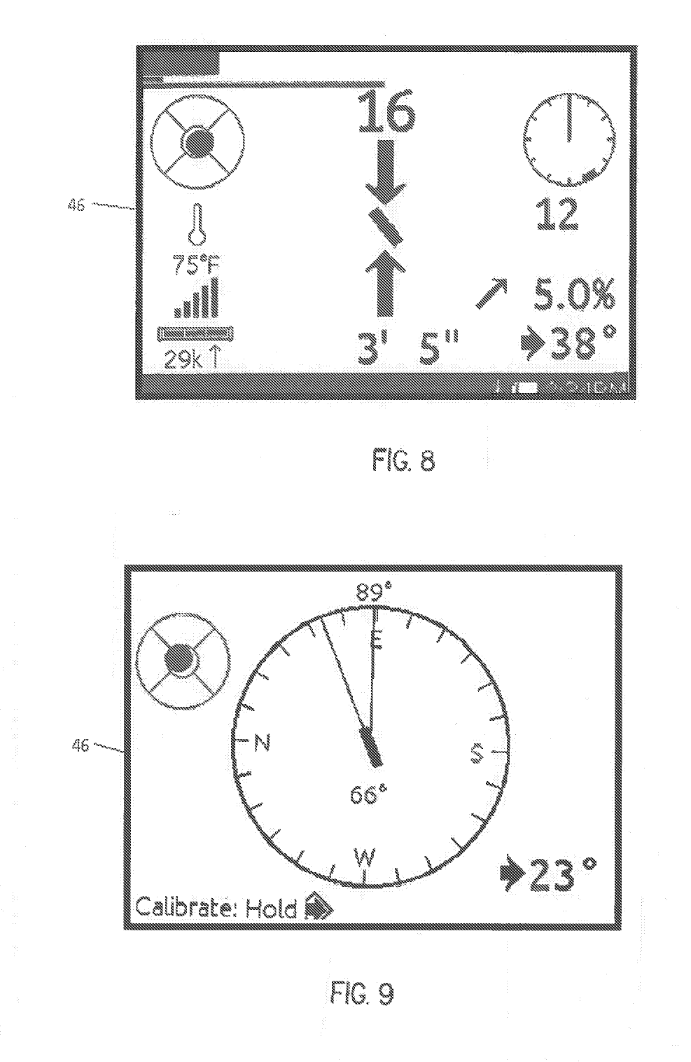

In one mode shown in FIG. 8, the visual display 46 provides course correction data, indicating that the boring tool should be steered up at a 5.0% grade and right until the boring tool has made a 38 degree turn. Other data conveyed in FIG. 8 includes the depth, orientation of the boring tool, frequency, signal strength, battery power, and clock orientation of the boring tool. Additional information can be provided on the display 46 as needed.

In another mode shown in FIG. 9, the visual display 46 shows the absolute compass heading calculated by the processor and the tracker heading relative to magnetic north. In the example of FIG. 9, the downhole tool is at 66 degrees east of magnetic north. The tracker is pointing 89 degrees east of north, or one degree north of due east. Therefore, a turn of 23 degrees to the right is required to bring the transmitter in line with the tracker.

Various modifications can be made in the design and operation of the present invention without departing from its spirit. Thus, while the principle preferred construction and modes of operation of the invention have been explained in what is now considered to represent its best embodiments, it should be understood that within the scope of the appended claims, the invention may be practiced otherwise than as specifically illustrated and described.

What is claimed is:

1. A tracker comprising:
a portable housing
a tri-axial antenna situated within the housing and configured to detect the magnetic field of a dipole source;
a compass situated within the housing; and
a processor situated within the housing and configured to receive signals from the antenna and the compass and to calculate the orientation for the underground transmitter relative to magnetic north.

2. The tracker of claim 1 further comprising an accelerometer.

3. A horizontal directional drilling system comprising:
a horizontal directional drill;
a drill string having a horizontal directional drill at a first end and a downhole tool at a second end;
an underground transmitter located proximate the downhole tool, wherein the underground transmitter emits a dipole magnetic field detectable by the tracker of claim 1; and
the tracker of claim 1.

4. The horizontal directional drilling system of claim 3 wherein the processor logs the orientation of the underground transmitter relative to magnetic north.

5. The horizontal directional drilling system of claim 4 wherein the processor maps the orientation and position of the transmitter.

6. The horizontal directional drilling system of claim 5 wherein the processor transmits a corrective steering signal to the horizontal directional drill in response to the orientation of the underground transmitter.

7. The tracker of claim 1 wherein the compass comprises a microelectromechanical magnetometer.

8. The tracker of claim 1 wherein the tri-axial antenna comprises a cubic printed circuit board.

9. The tracker of claim 1 wherein the tri-axial antenna comprises three mutually orthogonal coils.

10. The tracker of claim 9 wherein the three mutually orthogonal coils define equal areas and a coincident center point.

11. The tracker of claim 1 further comprising a handle disposed on the portable housing.

12. A method for determining an absolute heading of a downhole tool comprising:
moving a transmitter supported by and aligned with the boring tool along an underground borepath;
emitting a dipole magnetic field from the transmitter;
placing a receiving antenna at an above-ground location;
detecting the heading of the transmitter and downhole tool relative to the receiving antenna;
detecting the orientation of the receiving antenna relative to magnetic north with a compass;
calculating the absolute heading of the downhole tool using the orientation of the receiving antenna relative to magnetic north and the heading of the transmitter relative to the receiving antenna; and
steering the downhole tool in response to the calculated absolute heading.

13. The method of claim 12 wherein the receiving antenna is a tri-axial antenna.

14. The method of claim 12 in which the above-ground location is directly above the underground transmitter.

15. The method of claim 12 further comprising detecting a tilt orientation of the receiving antenna.

16. The method of claim 12 wherein the transmitter is located at a distal end of a horizontal directional drill string.

17. The method of claim 16 further comprising the step of steering the horizontal drill string based upon the course correction generated.

18. The method of claim 12 wherein the orientation of the receiving antenna relative to magnetic north is detected using a microelectromechanical compass.

19. The method of claim 12 further comprising logging an absolute position and orientation of the underground transmitter.

20. The method of claim 12 wherein the receiving antenna and the compass are collocated within a tracker housing.

21. The method of claim 12 further comprising advancing the transmitter after changing the course in response to the course correction and moving the receiving antenna to an additional above ground location.
